(19) United States
(12) Patent Application Publication
(10) Pub. No.: US 2006/0273177 A1
(43) Pub. Date: Dec. 7, 2006

(54) MFP which has the scan history management function and a method of managing the scan history in the MFP

(75) Inventors: Hye-jin Lee, Suwon-si (KR); Nam-seob Lim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/439,191

(22) Filed: May 24, 2006

(30) Foreign Application Priority Data
Jun. 3, 2005 (KR) 2005-47680

(51) Int. Cl. G06K 7/10

(52) U.S. Cl. 235/462.01

(57) ABSTRACT

An MFP and a method of managing the scan history in the MFP includes a scanning part scanning a document and creating image data; a barcode data generating part encoding a predetermined scan history information related to a scan work and creating the barcode data corresponding to the scan history information; and a controlling part controlling such that a transmission data is transmitted to a recipient's email address, after the barcode data is added to the image data and the transmission data is created. The scanned image data is added with the barcode data containing a scan performer, a scan performed place, and a scan performed point, and transmitted to the recipient's email address. The recipient is able to know a scan performer, a scan performed place, and a scan performed point, such that the scan history is easily managed.

### CROSS-REFERENCE TO RELATED APPLICATION

This application claims the benefit under 35 U.S.C. § 119(a) of Korean Patent Application No. 2005-47680, filed Jun. 3, 2005 in the Korean Intellectual Property Office, the entire disclosure of which is incorporated herein by reference.

### BACKGROUND OF THE INVENTION

1. Field of the Invention

Aspects of the present invention relate to a MFP and a method of managing the scan history in the MFP. More particularly, Aspects of the present invention relate to the MFP which has a scan history management and a method of managing the scan history in the MFP, such that a server administrator can easily manage history related to the scan performance, by expressing information on a scanning-performer, a scanning performing time, and data scanned with a barcode.

2. Description of the Related Art

Generally, a Multi Functional Product (MFP) is a multi-functional terminal embodied by integrating individually existing terminals (such as facsimile, a scanner, a printer, and/or a copier) into one single device. The MFP may be used independently or connected to a computer.

FIG. 1 is a block diagram of a system for transmitting data scanned at the MFP by a user to a recipient's email address. FIG. 2 is a flowchart provided to explain the method of transmitting the data scanned at the MFP by the user to the recipient's email address, using the system of FIG. 1. Referring to FIGS. 1 and 2, a user account is registered and stored at a server 10, through a user account registration process of inputting a user's own ID (S210). The user brings a selected document to the MFP (ex: 20a) and logs in with an ID registered with the server 10 (S220). The user sets various options related to the scan (S230) and requests scan work with respect to the document, by pressing an operation button (S240).

When the scan work is requested, a scanning part (not shown) of the MFP (ex: 20a) scans the document and creates image data. The created image data is stored at the server 10 through a network in a scan file (S250). The user accesses the server 10 at a host (ex: 30a) to search for the scan file and copies the scanned file to the host (ex: 30a) (S260). If the scan file is finished being copied and stored at the host (ex: 30a), the user transmits the scan file to the recipient's email address (S270).

The method of transmitting the data scanned to the recipient's email address at the MFP of FIG. 2 has a problem in that a scan history management gets difficult because the user cannot exactly obtain the information on the data scanned, a scanning performing time and a user performing the scanning.

### SUMMARY OF THE INVENTION

An aspect of the present invention provides a Multi Functional Product (MFP) which has a scan history management and a method of managing a scan history in the MFP, such that a server administrator can easily manage the history related to a scan performance such as a scanning-performer, a scanning place, and a scanning performing time, by expressing various information on scanning performance with a barcode, adding to the scan data and transmitting to an email address and or storing at the email address.

According to an aspect of the present invention, there is provided a MFP which has a scan history management and which comprises: a scanning part scanning a document and creating image data when a request to scan the document is input; a barcode data generating part encoding a predetermined scan history information related to a scan work and creating the barcode data corresponding to the scan history information; and a controlling part controlling a transmission of transmission data to a recipient's email address, the transmission data including the barcode data and the image data.

According to an aspect of the present invention, the predetermined scan history information includes a user's ID, a user's email address, an IP address of the MFP being currently used, a size of the image data, scanning performing time, an email address of the recipient, or combinations thereof.

According to an aspect of the present invention, the MFP further comprises a first storing part storing the image data and the barcode data.

According to an aspect of the present invention, the MFP further comprises a PC interfacing part transmitting the image data to an external host, and if the image data through the PC interfacing part is transmitted to the external host, the image data stored at the first storing part is deleted.

According to an aspect of the present invention, the image data stored at the first storing part is erasable.

According to an aspect of the present invention, the MFP further comprises a network communicating part transmitting the transmission data to a designated recipient's email address.

According to an aspect of the present invention, the MFP further comprises a user authenticating part creating a user account by storing the user's ID and email address to be inputted, and authenticating whether the user account is a registered user account by matching the user's ID and the stored ID.

According to an aspect of the present invention, the MFP further comprises a second storing part storing the input user's ID and email address.

According to an aspect of the present invention, the MFP further comprises an operating panel creating predetermined signals corresponding to various operation commands from the user and providing the created signals to the controlling part.

According to an aspect of the present invention, types of barcode data are set by the user.

A method of managing the scan history in a MFP according to an embodiment of the present invention comprises: scanning a document and creating image data according to a request to scan the document; encoding predetermined scan history information related to the scanning and creating barcode data corresponding the scan history information; and adding the barcode data to the image data while creating transmission data and transmitting the transmission data to a recipient's email address.

According to an aspect of the present invention, the predetermined scan history information includes a user's ID and email address, an IP address of the MFP being currently used, a size of the image data and scanning performing time, and/or email address of the recipient.

According to an aspect of the present invention, the method of further comprises, before scanning the document and creating the image data, storing the user's ID and email address to be inputted and creating the user's account; and authenticating whether the user account is a registered user account by matching the user's ID and the stored ID.

According to an aspect of the present invention, the adding the barcode data further comprises, when the transmission data is transmitted to the recipient's email address, the recipient outputs the transmission data, reads the barcode data part from the outputted transmission data using a separate barcode reading device, and extracts the scan history information.

According to an aspect of the present invention, the method further comprises storing the image data and the barcode data.

According to an aspect of the present invention, when the stored image data is transmitted to the external host, the transmitted image data is deleted.

According to an aspect of the present invention, the stored image data is erasable.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent and more readily appreciated by describing in detail exemplary embodiments thereof with reference to the accompanying drawings, wherein;

FIG. 1 is a block diagram of a system for transmitting the scanned data at a Multi Functional Product (MFP) by a user to a recipient's email address;

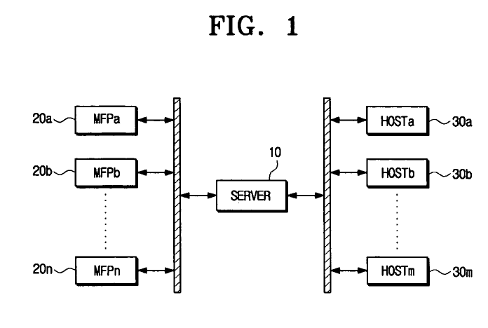

FIG. 2 is a flowchart provided to explain a method for transmitting the scanned data at the MFP by a user to a recipient's email address, using the system of FIG. 1;

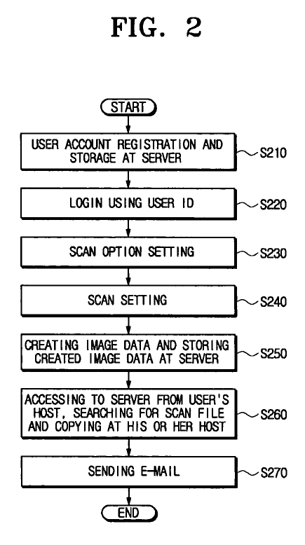

FIG. 3 is a block diagram showing a structure of the MFP which has a scan history management according to an embodiment of the present invention;

FIG. 4 is a flowchart provided to explain a method of managing the scan history in the MFP according to an embodiment of the present invention;

FIG. 5 is a user interface screen indicating the scan history according an embodiment of the present invention; and

FIG. 6 is a transmission data to be transmitted to a recipient's email address according to an embodiment of the present invention.

### DETAILED DESCRIPTION OF THE EMBODIMENTS

Hereinafter, an embodiment of the present invention will be described in detail with reference to the accompanying drawing figures. In the following description, like reference numerals are used for the like elements even in different drawings. The matters defined in the description such as a detailed construction and elements are nothing but the ones provided to assist in a comprehensive understanding of the invention. Thus, it is apparent that aspects of the present invention can be carried out without those defined matters. Also, well-known functions or constructions are not described in detail since they would obscure the invention in unnecessary detail.

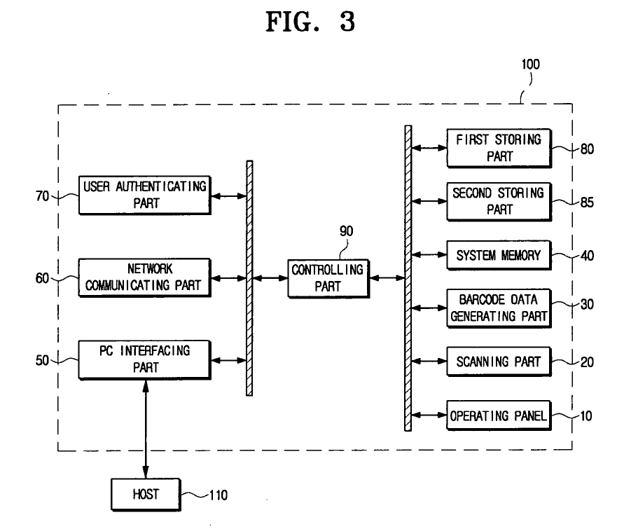

FIG. 3 is a block diagram showing a structure of the Multi Functional Product (MFP) 100 which has a scan history management according to an embodiment of the present invention. Referring to FIG. 3, the MFP 100 has an operational panel 10, a scanning part 20, a barcode data generating part 30, a system memory 40, a PC interfacing part 50, a network communicating part 60, a user authenticating part 70, a first storing part 80, a second storing part 85, and a controlling part 90. While not shown, other components may be included in the MFP 100 and can include a printer, a copier, and/or a fax.

The system memory 40 stores a program for receiving and transmitting email, and accessing to a website. However, it is understood that the stored program need not allow accessing a website. Moreover, it is understood that the stored program can be used to access computers in public and/or private networks, and can implement messaging systems other than email such as instant messaging, peer-to-peer file transfer protocols, and other like mechanisms for moving data between network elements.

The operating panel (OPE) 10 has a key matrix including many number keys and function keys for setting the function on a menu. The OPE 10 offers key data created according to a key operation to the controlling part 90. A Liquid Crystal Display (LCD) is prepared inside the operating panel 10, to indicate a state of the MFP 100 and various information, under the control of the controlling part 90. However, it is understood that other types of displays can be used and that the display need not be part of the MFP 100. Additionally, while described as being separate, it is understood that the key matrix of the OPE 10 can be combined with the display such as in a touch screen display.

The scanning part 20 reads a document, changes the document into the image data, and transmits the image data to the controlling part 90. The first storing part 80 stores the image data scanned at the scanning part 20 under the control of the controlling part 90. While not required, it is understood that the controlling part 90 can perform additional functions on the image data, such as performing Optical Character Recognition (OCR) on the image data.

The controlling part 90 controls the entire MFP 100 according to a program of a set mode. In particular and while not required in all aspects, the controlling part 90 determines a size of the image data scanned, when the scanning was performed, an IP address of the MFP 100 which performed the scanning, and ID and email address of a current log-in user. The controlling part 90 provides this data to the barcode data generating part 30. The barcode data generating part 30 creates barcode data based on various information provided from the controlling part 90. The barcode data generating part 30 encodes based on ID and email address of a log-in user, IP address of the MFP 100, the size of the image data scanned, and scanning performing time, and generates the barcode data. The barcode data generated at the barcode data generating part 30 is stored at the first storing part 80. It is understood that the various information can include all or fewer than the above information, and can also include project identification codes, archiving information, and/or scan dates.

According to control of the controlling part 90, data read at the scanning part 20 is sent to a host 110, or information transmitted from the host 110 is transmitted to the MFP 100 through the PC interfacing part 50, such that the host 110 and the MFP 100 can communicate each other.

The user authenticating part 70 creates a user account using ID input from the user and registers the user account. The user authentication part 70 uses the registered user account to judge whether a user current logging in is registered through authentication. The second storing part 85 stores the user's ID and email address input by the user, to create the user account under the control of the controlling part 90. The network communicating part 60 allows data for a user to transmit such as the scanned image data and the barcode data to be transmitted to the recipient's email. While shown as separate, it is understood that the first and second storing parts 80 and 85 can be parts of a common memory and/or that one or both of the first and second parts 80, 85 can be detachable or otherwise accessed across a network. Additionally, while described as comparing stored and input user IDs and email addresses, it is understood that other mechanisms can be used to authenticate a user without requiring an input user ID and/or the email address, such as password systems, biometric authentication mechanisms and card-key authentication systems in which the user ID is verified on a chip or card.

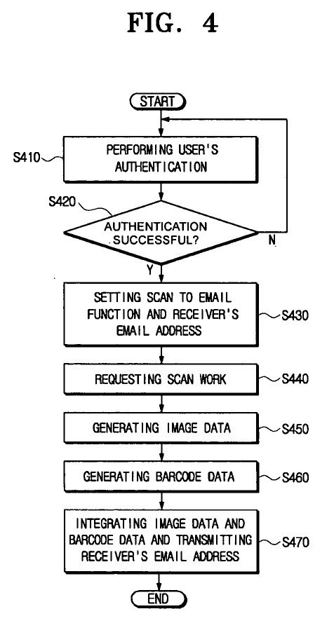

FIG. 4 is a flowchart provided to explain a method of managing the scan history in the MFP according to an embodiment of the present invention. While not required, it is understood that one or all of the operations of the method of FIG. 4 can be implemented as computer software encoded on one or more computer readable media accessible by one or more computers.

According to an embodiment of the invention, the user needs to have established the user account at the MFP 100 before S410. According to an embodiment of the present invention, at a point of the user account registration, the user inputs an ID and email address through a key inputting part of the operating panel 10. The controlling part 90 stores the user ID and email address input for the user account registration to the second storing part 85. However, it is understood that the user account creation can be performed during the process so as to simultaneously provide authentication and account registration in S410. Additionally, it is understood that account registration can be through a combination not requiring an email address with the user ID, such as where the combination is of a user ID and password or a password and an email account.

Referring to FIG. 4, when the user inputs an ID through the operating panel, the user authenticating part 70 matches the input ID input by the user and ID preset stored in the second storing part 85, and authenticates whether the user is a registered user or not (S410). If the user authentication is successful (S420), the user logs in and is able to set scan related various options (S430). In order to describe operations of the present invention, the user is assumed to set a scan to an email function and a recipient's email address as scan related options (S340). According to an embodiment of the present invention, the scan-to-email function refers to a function of automatically transmitting to a designated recipients' email addresses transmission data having integrated data generated based on scanned image data and scanning-related various information. The scanning-related various information is included in barcode data or other like machine readable indicia, examples of which are as described in detail below.

If the scan-to-email function is set, the user is able to designate email recipients. Where the scan-to-email function is not set or the recipient's email address is not designated, the scanned image data will not be automatically transmitted to the recipient's email. As such, the scanned image data is stored to be manually emailed and/or printed.

According to an embodiment of the present invention, the user is able to designate the types of barcode, which will be described more in detail below.

When the scan-to-email function and recipient's email address are set in (S430), the user presses an operating button prepared at the operating panel 10 and requests scan work for a document on the copyholder (S440). It is up to the user to select to set scan related various options, especially the scan-to-email function. While described as a scan-to-email function, it is possible to otherwise transmit the transmission data, such as via facsimile, using instant messaging, FTP transfers, peer-to-peer networks, and/or through storage on portable media.

If the scan work is requested, the scanning part 20 scans the document and creates the image data (S450). The controlling part 90 stores the image data generated at the scanning part 20 to the first storing part 80. The controlling part 90 determines the information on the size of the image data and the scanning performing time, and provides the information to the barcode data generating part 30. The controlling part 90 figures out IP address of the MFP 100, and ID and email address of the current log-in user, and provides to the barcode data generating part 30 the information (e.g., the IP address of the MFP 100, and the ID and email address of the current log-in user). The reason why the user offers the IP address of the MFP 100 to the barcode data generating part 30 and creates the barcode data with the IP address is that the user intends to allow recipients to identify the MFP transmitting the scanned data. However, it is understood that all of this information is not required in all aspects of the invention, such as where the identity of the user or MFP is not needed.

The barcode data generating part 30 generates the barcode data, based on the scan history information offered from the controlling part 90 (S640). By way of example, the barcode data generating part 30 encodes, based on a log-in user's ID (ex: Thjlee), the email address (ex: name@company.com), the IP address (ex: 111.22.33.44) of the MFP 100, the size of the scanned image data (ex: 34221) and a scanning performing time (ex: 2005-03-05). If the main address (ex: name2@company.com) of the email recipient is designated by the user, the barcode data generating part 30 encodes the recipient's email address and generates the barcode data. However, it is understood that other types of information can be included in the scan history instead of or in addition to the above examples, such as information relating to identification for a project being performed by the user, billing and/or pricing information for the scanning operation, a physical address of the scanning device, or other information related to the document being scanned. Moreover, if the scanned document is a received fax, the history can include the date of receipt and number of pages. Further, where the scanned document is part of a copy job, the history can include the number of copies made during the particular copy job.

According to aspects of the invention, the operating panel 10 allows a selection between different types of barcodes on a main screen of the operating panel 10. As such, the barcode data is generated based on designated types of barcode on the menu. Examples of different barcodes selectable using the operating panel 10 are set forth in Table 1 below.

TABLE 1

| | Barcode |
|---|---|
| 1 | Maxicode |
| 2 | PDF417 |
| 3 | Datamatrix |
| 4 | Aztec |
| 5 | Codec49 |

The barcode is largely divided into one-dimensional barcode storing information in one direction and two-dimensional barcode storing information upward, downward, left and right. In table 1, Aztec and Codec49 are one-dimensional barcode, while Maxicode, PDF417, and Datamatrix are two-dimensional barcode. However, it is understood other single and multidimensional and/or holographic barcodes can be used, and that other types of optical and non-optical machine interpretable indicia can be used.

The controlling part 90 stores the barcode data generated by the barcode data generating part 30 in the first storing part 80. Likewise, by storing the barcode data in the first storing part 80, the user is able to access to the host 110 or the MFP 100, and access the barcode data stored in the first storing part 80. Accordingly, in case that the image data or the barcode data is not able to be automatically transmitted to the recipient's email due to unset email of the recipient, the user may bring the information on the barcode data and the image data stored at the first storing part 80 and use. As such and while not required, the first storing part 80 can be detachable media and/or a detachable drive.

In contrast, when the user is allowed to bring the image data only stored at the first storing part 80 and the user brings the image data, the image data stored at the first storing part 80 is deleted and the barcode data is stored at the first storing part 80 of the MFP 100 as it is, such that the entire storage capacity of the MFP 100 is reduced and the scanned image data is managed. The image data is provided to the administrator of the MFP 100 through the scan history indicated user interface screen (not shown), to manage the scan history, such that security may be enhanced.

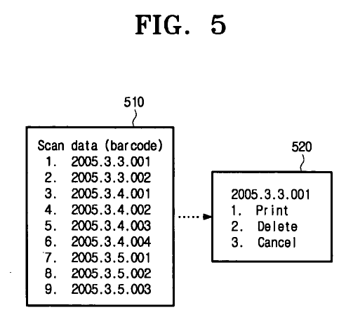

FIG. 5 is a user interface screen indicating the scan history according an embodiment of the present invention. While not required, the screen can be shown in a display of the MFP 100, the host 110, or otherwise connected to the MFP 100. Referring to FIG. 5, if the administrator clicks on No. 1 (2005.3.3.001) on the scan history indicated user interface screen 510, a submenu screen 520 is displayed. If the administrator clicks on No. 1 on the submenu screen 520, various information on a first scan work on Mar. 3, 2005 (ex: a user ID, user's email address, IP address of the scan performed MFP, the size of the image data, and the scan performed point) is output in a barcode form. Likewise, the administrator outputs the scan work related information in a barcode form and be informed about various data on the scan work, such that information security may be enhanced. The administrator can be a person manually selecting the indicated items at an administration computer and/or a program to automatically track scans, such as a document management system, billing program, and archiving system.

If the image data and the barcode data are created in S450, S460, the controlling part 90 integrates the image data and the barcode data together and controls the integrated data to be transmitted to the email addresses of designated recipients through the network communicating part 60 (S470).

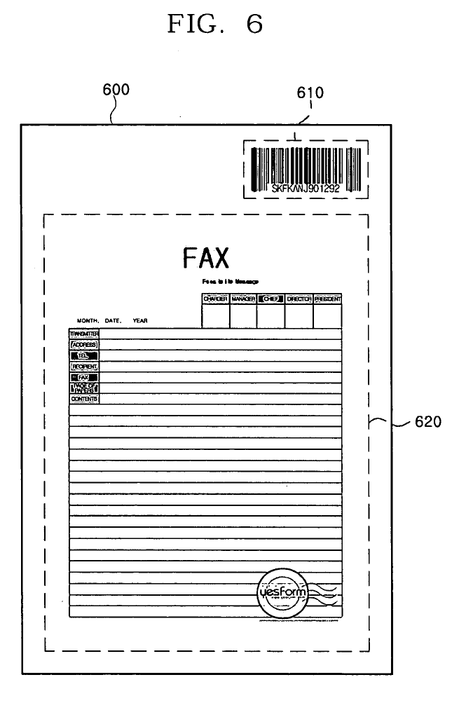

FIG. 6 shows the transmission data 600 to be transmitted to the email address of the recipient according to an embodiment of the present invention. Referring to FIG. 6, the scanned parts of the image data 610 and the data part 620 are integrated into the transmission data 600. When the transmission data 600 is transmitted to the recipient's email address and output, the recipient reads the data barcode 610, using a separate OCR (Optical Character Reader) mounted with a barcode reader and extracts the barcode information. The recipient is thus able to confirm a scan performer, a scan performed place, and a scan performed point, such that the scan history is easily managed. However, it is understood that the barcode reader need not be included with an OCR and/or that other indicia recognition technology can be used.

As abovementioned, according to an embodiment of the present invention, the scanned image data is added with the barcode data containing a scan performer, a scan performed place, and a scan performed point, and transmitted to the recipient's email address. The recipient is able to know a scan performer, a scan performed place, and a scan performed point, such that the scan history is easily managed.

According to an embodiment of the present invention, the barcode data only is stored at the MFP, and the entire storage capacity may be reduced. An administrator outputs the stored barcode data only, to obtain various information on the scan work by the stored barcode data only, such that data security is enhanced.

While aspects of the invention has been shown and described with reference to certain embodiments thereof, it will be understood by those skilled in the art that various changes in form and details may be made therein without departing from the spirit and scope of the invention as defined by the appended claims and equivalents thereof.

What is claimed is:

1. A method of managing a scan history comprising:
scanning a document and creating image data;
encoding predetermined scan history information related to the scanning and creating barcode data corresponding to the scan history information;
adding the barcode data to the image data to create the transmission data; and
transmitting the transmission data to a recipient's email address.

2. The method of claim 1, wherein the predetermined scan history information comprises one out of a user's ID and email address, an IP address of the MFP being currently used, a size of the image data and scanning performing time, email address of the recipient, or combinations thereof.

3. The method of claim 1, further comprising before the scanning:
storing a user ID and email address to be inputted and creating a user account; and
authenticating whether the user account has a registered user account by matching the user ID and a stored ID of the registered user account.

4. The method of managing the scan history of claim 1, further comprising, after the transmission data is transmitted to the recipient's email address, the recipient outputs the transmission data, reads the barcode data from the outputted transmission data using a separate barcode reading device and extracts the scan history information.

5. The method of managing the scan history of claim 1, further comprising storing the image data and the barcode data.

6. A document capture apparatus, comprising:
a scanning part to scan and create an electronic image of a document;
an indicia generating part to create machine-readable indicia including information related to the scanning and creation of the electronic image of the document; and
a controlling part to create a combined document including the electronic image and the indicia such that, when another apparatus receives the combined document, the information related to the electronic image is read from indicia of the combined document.

7. The document capture apparatus of claim 6, wherein the indicia comprises a barcode including the information, and the controlling part creates the combined document to include a first area including the electronic image and a second area including the barcode.

8. The document capture apparatus of claim 7, wherein the first area is other than the second area.

9. The document capture apparatus of claim 6, wherein the information related to the electronic image includes when the document was scanned, a location of the document capture apparatus, and/or a location of a recipient of the combined document.

10. The document capture apparatus of claim 6, wherein the controlling part further messages the combined document to the another apparatus, and the information related to the electronic image includes routing information to a recipient of the message.

11. The document capture apparatus of claim 6, wherein:
the indicia generating part has a capacity to create a first type of indicia and a second type of indicia other than the first type, and
the controlling part receives a selection indication selecting between the first and second types, and controls the indicia generating part to create the selected one of the first and second type of indicia with the information according to the received selection indication.

12. The document capture apparatus of claim 11, wherein the first type of indicia comprises a one-dimensional optical indicia in which the information is expressed linearly, and the second type of indicia comprises a multi-dimensional optical indicia in which the information is expressed in multiple directions.

13. The document capture apparatus of claim 6, further comprising an authentication unit which authenticates a requestor's identification, wherein the controlling part prevents an unauthenticated requestor from accessing the scanning part and/or from messaging the combined document from the document capture apparatus.

14. The document capture apparatus of claim 6, further comprising a memory which stores a plurality of created indicia for a corresponding plurality of combined documents, wherein the controlling part generates a list of the created indicia such that the information in each indicia is accessible without accessing the corresponding combined documents.

15. The document capture apparatus of claim 6, further comprising an interface through which the document capture apparatus connects to a network and through the controlling part messages the combined document to the another apparatus across the network.

16. The document capture apparatus of claim 15, wherein the controlling part generates an email message in order to message the combined document to the another apparatus.

17. The document capture apparatus of claim 15, wherein the indicia is readable by an optical character recognition system of the another apparatus Or by a barcode reader included in the optical character recognition system of the another apparatus.

18. A method of managing a scan history comprising:
scanning a document to create image data using a scanning apparatus;
encoding information related to the scanning of the document into a machine-readable indicia at the scanning apparatus; and
combining the machine-readable indicia with the image data to form transmission data readable by another apparatus such that the another apparatus reproduces the information from the machine-readable indicia.

19. The method of claim 18, further comprising:
messaging the transmission data to a recipient's address across a network; and
receiving the message at the another apparatus.

20. The method of claim 19, wherein the machine-readable indicia comprises a barcode, and wherein the barcode comprises a multi-dimensional barcode.
